(19) United States
(12) Patent Application Publication
(10) Pub. No.: US 2026/0021755 A1
(43) Pub. Date: Jan. 22, 2026

(54) REAR VEHICLE SEAT TRIM COVERING CLOSEOUT

(71) Applicant: GM GLOBAL TECHNOLOGY OPERATIONS LLC, DETROIT, MI (US)

(72) Inventors: Hanwon Jung, Gyeonggi-do (KR); Jungseok Nam, Incheon (KR)

(21) Appl. No.: 18/776,381

(22) Filed: Jul. 18, 2024

(51) Int. Cl. B60N 2/28

(52) U.S. Cl. CPC B60N 2/289; B60N 2/2893

(57) ABSTRACT

A seat assembly of a vehicle includes a seat cushion, a seat back connected to and extending from the seat cushion, and an access opening positioned in one of the seat cushion or the seat back. The access opening configured to allow for user access to a body child seat anchor feature for installation of a child seat. The body child seat anchor feature secured to a vehicle body or seat frame. The access opening including a closure operated by attractive magnetic forces.

### INTRODUCTION

The subject disclosure relates to vehicles, and more particularly to the covering of child seat anchorage features at rear seats of vehicles.

Vehicle rear seats include vehicle anchorage features for secondary child seats to secure the child seats in the vehicle. These vehicle anchorage features typically include a metal loop or ring fixed to the vehicle body via the rear seat. A complimentary seat anchorage feature on the child seat, often a strap or the like, is engaged to the vehicle anchorage feature to secure the child seat in the vehicle.

When not in use, meaning when a child seat is not installed, the vehicle anchorage features are either left exposed, or are hidden by, for example, a plastic cover, a zipper in the vehicle seat, or an overlap in the seat trim fabric. The cover or zipper is meant to improve a user perception of the appearance by hiding the vehicle anchorage feature.

To install the child seat, the user must then either typically remove the plastic cover, open a zipper and/or open the seat trim fabric manually via a finger to make an access path to the vehicle anchorage feature to install the seat anchorage feature thereto.

### SUMMARY

In one exemplary embodiment, a seat assembly of a vehicle includes a seat cushion, a seat back connected to and extending from the seat cushion, and an access opening positioned in one of the seat cushion or the seat back. The access opening configured to allow for user access to a body child seat anchor feature for installation of a child seat. The body child seat anchor feature secured to a vehicle body or seat frame. The access opening including a closure operated by attractive magnetic forces.

In addition to one or more of the features described herein the access opening includes at least two opposing edges. The closure includes magnetic elements embedded in the at least two opposing edges.

In addition to one or more of the features described herein the magnetic elements include a magnetic string or wire.

In addition to one or more of the features described herein the magnetic elements are enclosed in a hem of each of the at least two opposing edges.

In addition to one or more of the features described herein the magnetic elements are enclosed in edge trim portions of secured to the at least two opposing edges.

In addition to one or more of the features described herein the closure is biased toward a closed position by the attractive magnetic forces.

In addition to one or more of the features described herein the access opening includes one of a slit or a flap.

In another exemplary embodiment, a vehicle includes a vehicle body defining a passenger compartment, and one or more vehicle seats positioned inside the passenger compartment. A vehicle seat of the one or more vehicle seats includes a seat cushion, a seat back connected to and extending from the seat cushion, and an access opening positioned in one of the seat cushion or the seat back. The access opening is configured to allow for user access to a body anchor feature for installation of a child seat. The body anchor feature is secured to the vehicle body. The access opening includes a closure operated by attractive magnetic forces.

In addition to one or more of the features described herein the access opening includes at least two opposing edges. The closure includes magnetic elements embedded in the at least two opposing edges.

In addition to one or more of the features described herein the magnetic elements include a magnetic string or wire.

In addition to one or more of the features described herein the magnetic elements are enclosed in a hem of each of the at least two opposing edges.

In addition to one or more of the features described herein the magnetic elements are enclosed in edge trim portions of secured to the at least two opposing edges.

In addition to one or more of the features described herein the closure is biased toward a closed position by the attractive magnetic forces.

In addition to one or more of the features described herein the access opening includes one of a slit or a flap.

In addition to one or more of the features described herein the child seat anchor feature is one of a loop or a ring secure to the vehicle body.

In addition to one or more of the features described herein the seat assembly is positioned in a rear seat row of the vehicle.

In yet another exemplary embodiment, a method of installing a child seat to a vehicle includes opening a closure of an access opening of a seat assembly. The access opening allows a user access to a body anchor feature secured to the vehicle body. A child seat anchor feature of the child seat is secured to the body anchor feature to secure the child seat to the vehicle. The closure is operated by attractive magnetic forces.

In addition to one or more of the features described herein the child seat anchor is removed from the body anchor feature, and the access opening automatically closes via the attractive magnetic forces.

In addition to one or more of the features described herein the access opening includes at least two opposing edges, and the closure includes magnetic elements embedded in the at least two opposing edges.

In addition to one or more of the features described herein the magnetic elements include a magnetic string or wire.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of an embodiment of a vehicle;

FIG. 2 is a schematic plan view of an embodiment of a passenger compartment of a vehicle;

FIG. 3 is a perspective view of an embodiment of a rear seat row of a vehicle;

FIG. 4 is a schematic illustration of an embodiment of a vehicle lower anchor feature;

FIG. 5 is an illustration of a seat assembly including an embodiment of an access opening with a magnetic closure;

FIG. 6 is a cross-sectional view of an embodiment of a magnetic closure in a closed position at an access opening of a seat assembly;

FIG. 7 is a cross-sectional view of an embodiment of a magnetic element secured at a trim edge of a seat assembly;

FIG. 8 is another cross-sectional view of an embodiment of a magnetic element secured at a trim edge of a seat assembly;

FIG. 9 is an illustration of a seat assembly including another embodiment of an access opening with a magnetic closure; and

FIG. 10 is an illustration of a seat assembly including yet another embodiment of an access opening with a magnetic closure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

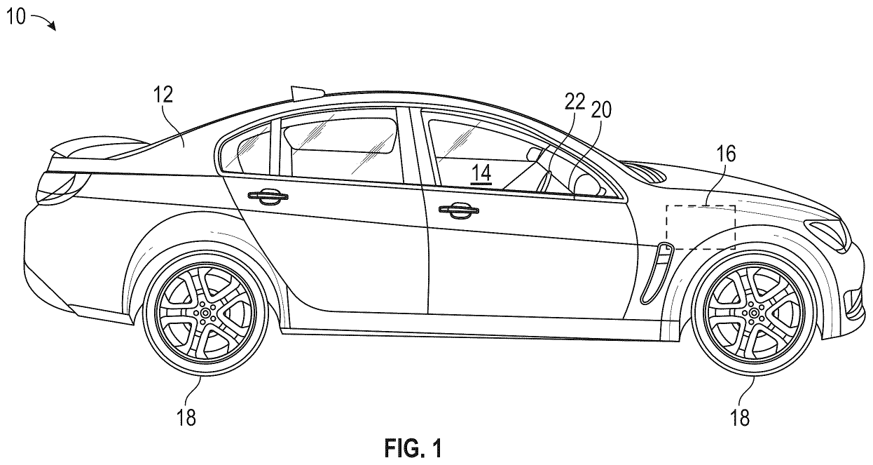

In accordance with an exemplary embodiment, illustrated in FIG. 1 is an embodiment of a vehicle 10. The vehicle 10 includes a vehicle body 12 defining a passenger compartment 14. The vehicle 10 further includes a powertrain 16 providing energy for propulsion and electrical power for operation of the vehicle systems. A plurality of wheels 18 are operably connected to the powertrain 16, and at least two of the wheels 18 are steerable. An instrument panel 20 is located in the passenger compartment 14, and a steering assembly 22 extends from the instrument panel 20 into the passenger compartment 14.

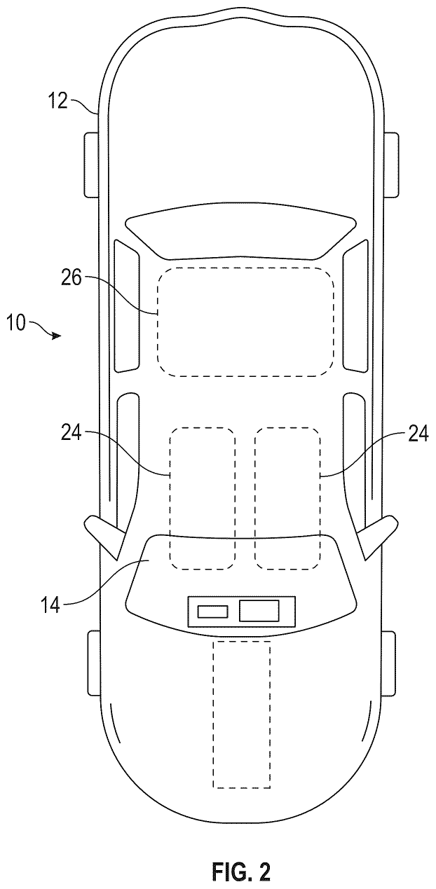

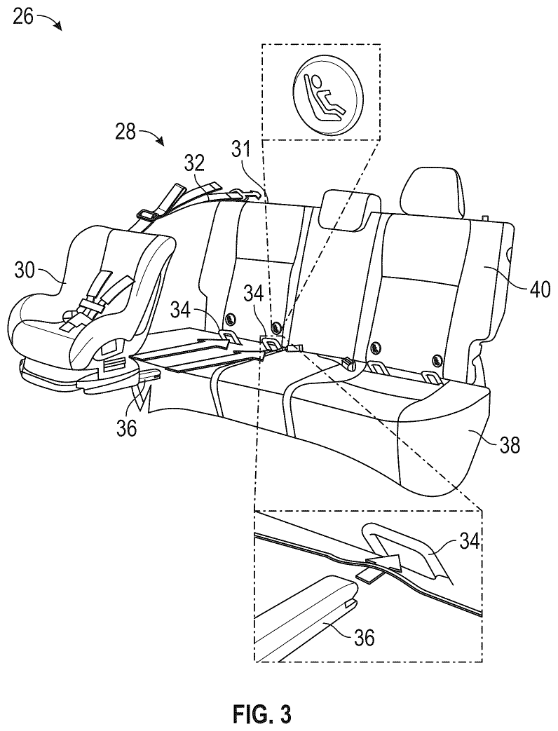

Referring now to FIG. 2, the passenger compartment 14 includes one or more front row seats 24 and one or more rear seat rows 26, depending on the vehicle 10 configuration disposed rearward of the from row seats 24. Illustrated in FIG. 3 is an exemplary embodiment of a rear seat row 26. The rear seat row 26 includes an anchorage location 28 for a child seat 30 to be secured thereto. While one anchorage location 28 is illustrated in FIG. 3, one skilled in the art will readily appreciate that in other embodiments two or more anchorage locations 28 may be utilized.

Each anchorage location 28 includes a vehicle upper anchor feature 31, such as a metal ring or loop, fixed to the vehicle body 12 and to which a complimentary seat upper anchor feature 32 of the child seat 30, such as a hook, a strap or the like, is connected. Additionally, the anchorage location 28 includes one or more vehicle lower anchor features 34, which are, for example metal loops or rings, secured to the vehicle body 12. The child seat 30 includes one or more complimentary lower seat anchor features 36, such as hooks or straps, that are installed to respective vehicle lower anchor features 34. The child seat 30 is thus secured in the vehicle 10.

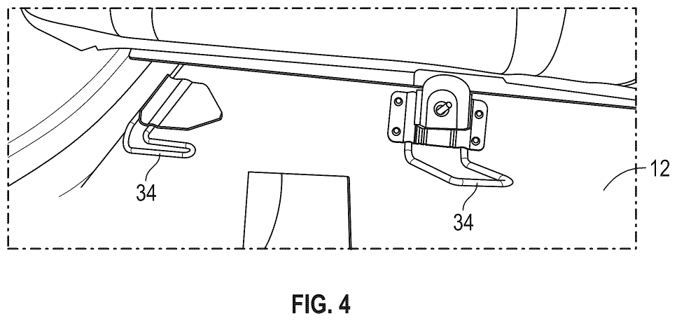

As seen in FIG. 4, the vehicle lower anchor features 34 are secured to the vehicle body 12 by, for example, welding or bolting. Referring again to FIG. 3, the rear seat row 26 includes a rear seat cushion 38 and a rear seat back 40 extending upwardly from the rear seat cushion 38 to define the rear seat row 26. To allow access to each vehicle lower child seat anchor feature 34 by a user for installation of the corresponding lower child seat anchor feature 36 thereto, the rear seat row 26 includes a child seat anchor access opening 42 defined therein. In some embodiments, such as shown herein, this child seat anchor access opening 42 is defined in the rear seat cushion 38.

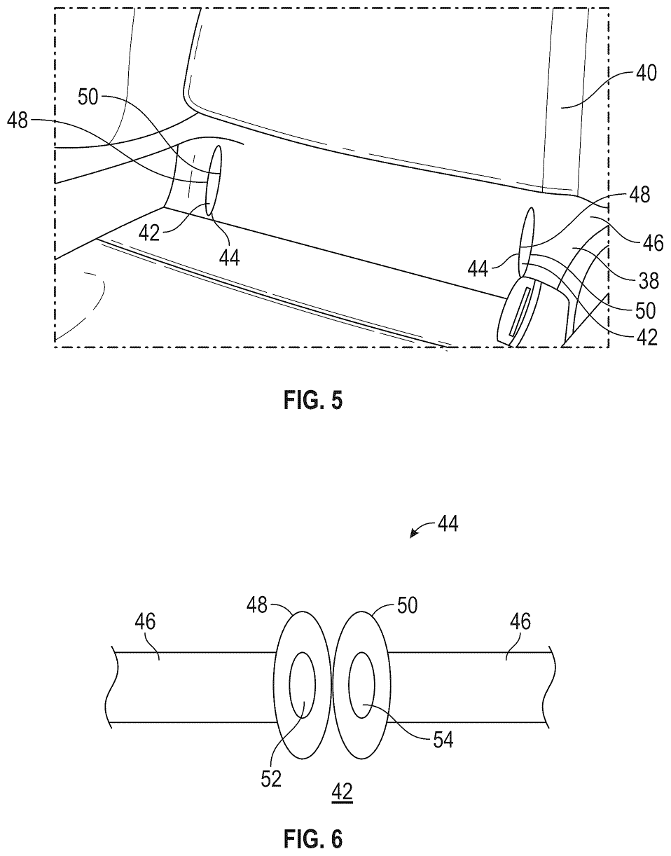

Referring now to FIGS. 5 and 6, the child seat anchor access opening 42 includes a closure 44 to close the child seat anchor access opening 42 when the child seat 30 is not installed, thereby covering the vehicle lower child seat anchor feature 34. In the embodiment of FIG. 5, the child seat anchor access opening 42 is defined as a vertical slit in a seat cushion outer surface 46, the seat cushion outer surface 46 being a portion of seat cushion trim or seat cover of the rear seat cushion 38. The vertical slit for child seat anchor access opening 42 includes a first trim edge 48 and an opposing second trim edge 50 defining opposing sides of the child seat anchor access opening 42. The closure 44 is defined by magnetic elements 52 and 54 embedded in each of the first trim edge 48 and the second trim edge 50, as illustrated in FIG. 6. The magnetic elements 52, 54 are configured to be magnetically attractive, such that magnetic element 52 is magnetically attracted to magnetic element 54 resulting in closure of the child seat anchor access opening 42. The magnetic attraction between magnetic elements 52 and 54 is such that the trim edges 48 and 50 automatically move toward each other when the child seat lower anchor feature 36 is not present in the child seat anchor access opening 42, thus closing the child seat anchor access opening 42 via magnetic forces, as illustrated in FIG. 6. In some embodiments, the magnetic elements 52 and 54 are formed from a magnetic string or wire.

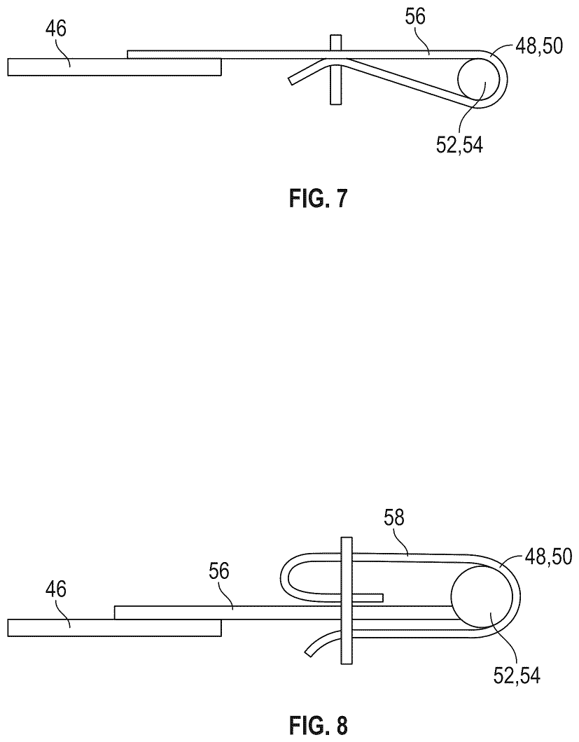

Referring to the cross-sectional view of FIG. 7, in one embodiment the magnetic elements 52, 54 are secured in the trim edges 48, 50 in a hem of the seat trim 56. Alternatively, in another embodiment illustrated in FIG. 8, the magnetic elements 52, 54 are secured in the trim edges 48, 50 by being at least partially enclosed in a trim edging 58 which is secured to the seat trim 56, thus defining the trim edges 48, 50. In each of these embodiments, the magnetic elements 52, 54 are secured into the trim edges 48, 50 via a sewing operation to the seat trim 56. It is to be appreciated, however, that these embodiments are merely exemplary and that in other embodiments the magnetic elements 52, 54 may be secured into the trim edges 48, 50 by other means, such as adhesives or mechanical fasteners such as snaps, staples or the like.

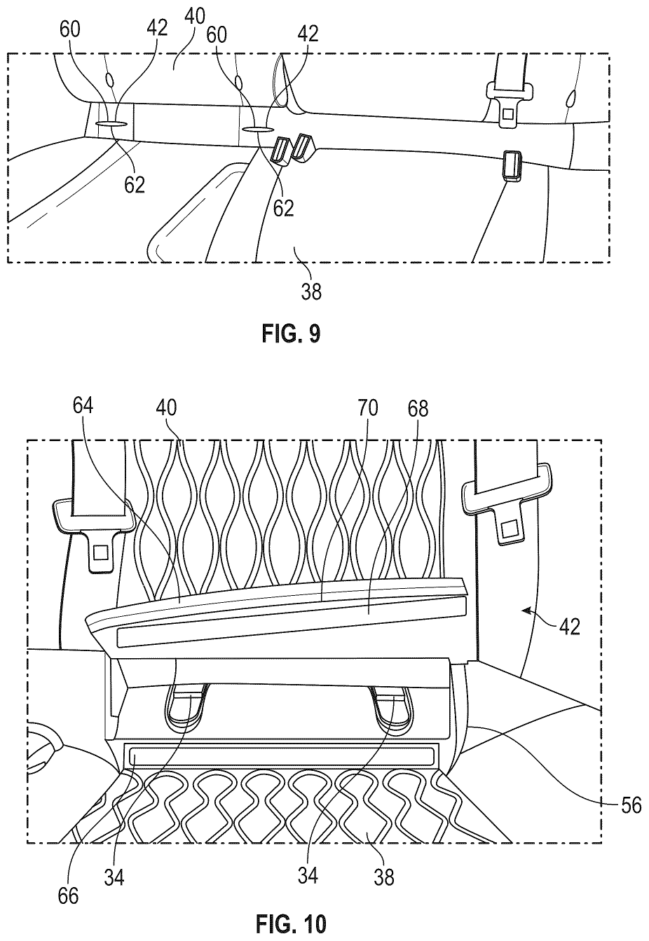

In other embodiments, the child seat anchor access opening 42 may have other configurations, and still include the closure 44 having magnetic elements 52, 54. For example, as illustrated in FIG. 9, in one embodiments the child seat anchor access opening 42 is defined as a horizontal slit having opposing trim edges 60, 62. Magnetic elements are embedded in the opposing trim edges 60, 62. In another embodiment illustrated in FIG. 10, the child seat anchor access opening is defined with a flap 64 formed in the seat trim 56 extending to the seat cushion 38 such that when the flap 64 is in the closed position, the flap 64 covers the vehicle lower anchor feature 34. In this embodiment, a first magnetic element 66 is disposed at, or embedded in the seat cushion 38 and a second magnetic element 68 is disposed at, or embedded in the flap 64 at a flap edge 70. The first magnetic element 66 and the second magnetic element 68 are attractive such that the magnetic elements 66, 68 are drawn toward each other to secure the flap 64 in the closed position by magnetic force when the child seat 30 is not installed.

The embodiments of the magnetic closure 44 disclosed herein provide for an easy to use mechanism for covering the lower child seat anchor feature 36 when the child seat 30 is not installed. The magnetic closure improves appearance of the rear seat row 26 and is a cost effective solution, when compared to utilizing an additional cover, such as a plastic cover.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The term “about” is intended to include the degree of error associated with measurement of the particular quantity based upon the equipment available at the time of filing the application. For example, “about” can include a range of #8% of a given value.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A seat assembly of a vehicle, comprising:
a seat cushion;
a seat back connected to and extending from the seat cushion; and
an access opening disposed in one of the seat cushion or the seat back, the access opening configured to allow for user access to a body child seat anchor feature for installation of a child seat, the body child seat anchor feature secured to a vehicle body or seat frame, the access opening including a closure operated by attractive magnetic forces.

2. The seat assembly of claim 1, wherein the access opening includes at least two opposing edges, and the closure comprises magnetic elements embedded in the at least two opposing edges.

3. The seat assembly of claim 2, wherein the magnetic elements include a magnetic string or wire.

4. The seat assembly of claim 2, wherein the magnetic elements are enclosed in a hem of each of the at least two opposing edges.

5. The seat assembly of claim 2, wherein the magnetic elements are enclosed in edge trim portions of secured to the at least two opposing edges.

6. The seat assembly of claim 1, wherein the closure is biased toward a closed position by the attractive magnetic forces.

7. The seat assembly of claim 1, wherein the access opening includes one of a slit or a flap.

8. A vehicle, comprising:
a vehicle body defining a passenger compartment; and
one or more vehicle seats disposed inside the passenger compartment, a vehicle seat of the one or more vehicle seats including:
a seat cushion;
a seat back connected to and extending from the seat cushion; and
an access opening disposed in one of the seat cushion or the seat back, the access opening configured to allow for user access to a body anchor feature for installation of a child seat, the body anchor feature secured to the vehicle body, the access opening including a closure operated by attractive magnetic forces.

9. The vehicle of claim 8, wherein the access opening includes at least two opposing edges, and the closure comprises magnetic elements embedded in the at least two opposing edges.

10. The vehicle of claim 9, wherein the magnetic elements include a magnetic string or wire.

11. The vehicle of claim 9, wherein the magnetic elements are enclosed in a hem of each of the at least two opposing edges.

12. The vehicle of claim 9, wherein the magnetic elements are enclosed in edge trim portions of secured to the at least two opposing edges.

13. The vehicle of claim 8, wherein the closure is biased toward a closed position by the attractive magnetic forces.

14. The vehicle of claim 8, wherein the access opening includes one of a slit or a flap.

15. The vehicle of claim 8, wherein the body anchor feature is one of a loop or a ring secured to the vehicle body.

16. The vehicle of claim 8, wherein the vehicle seat is disposed in a rear seat row of the vehicle.

17. A method of installing a child seat to a vehicle, comprising:
opening a closure of an access opening of a seat assembly, the access opening allowing a user access to a body anchor feature secured to a vehicle body; and
securing a child seat anchor feature of the child seat to the body anchor feature to secure the child seat to the vehicle;
wherein the closure is operated by attractive magnetic forces.

18. The method of claim 17, further comprising:
removing the child seat anchor feature from the body anchor feature; and
automatically closing the access opening via the attractive magnetic forces.

19. The method of claim 17, wherein the access opening includes at least two opposing edges, and the closure comprises magnetic elements embedded in the at least two opposing edges.

20. The method of claim 19, wherein the magnetic elements include a magnetic string or wire.
